(19) United States
(12) Patent Application Publication
(10) Pub. No.: US 2007/0054983 A1
(43) Pub. Date: Mar. 8, 2007

(54) Light-scattering antistatic and bright thermoplastic composition

(76) Inventors: Heinz Pudleiner, Krefeld (DE); Klaus Meyer, Dormagen (DE); Claus Rudiger, Krefeld (DE); Stefan Janke, Bruggen (DE); Fumika Kaneko, Tokyo (JP)

Correspondence Address: BAYER MATERIAL SCIENCE LLC, 100 BAYER ROAD, PITTSBURGH, PA, 15205, US

(21) Appl. No.: 11/507,237

(22) Filed: Aug. 21, 2006

(30) Foreign Application Priority Data
Aug. 25, 2005 (DE) 102005040315.8

(51) Int. Cl. C09D 151/00; C08K 5/41

(52) U.S. Cl. 523/201; 524/155

(57) ABSTRACT

A film comprising transparent polycarbonate, transparent, acrylate-based polymeric particles and an antistatic agent is disclosed. The particles have core-shell morphology and their average diameter is 1 to 100 μm. The film that may be multilayered is suitable as a diffuser of flat screens.

### FIELD OF THE INVENTION

This relates to a composite film and in particular to a polycarbonate composite diffuser film for flat screens.

### BACKGROUND OF THE INVENTION

Light-scattering translucent products made from polycarbonate with various light-scattering additives and shaped articles produced therefrom are already known from the prior art.

U.S. Patent application 2004/0066645 A1 disclosed light-scattering materials which contain 0.2 to 5% of light-scattering particles (e.g. poly(acrylates), having transmittance greater than 70% and haze of at least 10%. The scattering additive has an average diameter of 1 to 10 μm.

JP 07-090167 disclosed a light-scattering plastic which consists of 1 to 10% of particles which have a refractive index of 1.5 or below and a particle size of 1 to 50 μm, and 90 to 99% of an aromatic polycarbonate, wherein the particles are incompatible with aromatic polycarbonate. Acrylate, polystyrene, glass, titanium dioxide or calcium carbonate particles are used as the scattering additives.

EP 0 269 324 B1 disclosed a thermoplastic composition having light scattering properties containing as a scattering additive 0.1 to 10% spherical polymeric particles having core/shell morphology wherein the core is acrylate.

The light diffuser disclosed in EP 0 634 445 B1 entails polycarbonate and a presently relevant core/shell structured scattering additive (Paraloid EXL 5137) in combination with inorganic particles, wherein 0.001 to 0.3% of these particles, for example titanium dioxide, contribute towards improved aging resistance and thus color stability. This advantage is particularly important in those cases when compounds with high content of scattering agent (>2%) are exposed to elevated service temperatures (for example 140° C.) over an extended period (>500 hours).

EP 1 404 520 describes molding compositions and multilayer films which contain perfluoroalkylsulfonic acid salts as an antistatic agent.

EP 1 210 388 describes the use of perfluoroalkylsulfonic acid salts as antistatic agents.

U.S. Patent application 2004/0228141 describes antistatic light-scattering PC films in thicknesses of 0.025 to 0.5 mm which contain fluorinated phosphonium sulfonates as antistatic agents and optionally an acrylic-based scattering additive. Concentrations of at least 1 wt. % of additive are required in order to achieve sufficient activity. This concentration results in distinct turbidity in the product.

JP 11-005241 describes light-scattering sheets based on PMMA, which consist of a base layer with inorganic scattering pigments and a transparent outer layer with an antistatic agent. The long-chain perfluoroalkylsulfonic acid salt metal salts give rise to turbidity even in small film thicknesses.

However, when these films are handled, i.e. during sawing and on handling during assembly of the flat screens, the problem arises that these sheets fairly readily develop a static charge and thus strongly attract dust onto their surface. This surface dust dramatically impairs the optical properties of the films. As a result, the luminance of the backlight units (BLUs) used in the flat screens is distinctly reduced. The object of the present invention is accordingly to provide diffuser films which, due to reduced surface resistance, exhibit reduced electrostatic charging and unimpaired optical properties.

Diffuser films known from the prior art exhibit unsatisfactory color constancy with simultaneously elevated brightness.

A backlight unit (direct light system) is in principle of the structure described below. It generally includes a casing, in which, depending on the size of the backlight unit, a variable number of fluorescent tubes, known as CCFLs (Cold Cathode Fluorescent Lamps) are arranged. The inside of the casing is provided with a light-reflective surface. A diffuser sheet lies on this illumination system, said sheet having a thickness of 1 to 3 mm, preferably a thickness of 2 mm. On the diffuser sheet is located a set of films which may have the following functions: light scattering (diffuser films), circular polarizers, focussing of the light in the forwards direction by “brightness enhancing films” (BEF) and linear polarizers. The linear polarizing film is directly beneath the LCD (Liquid Crystal Display) which is located on top.

The object underlying the invention was to provide films of antistatic thermoplastic molding compositions, the optical quality of which, in particular brightness in the backlight unit of LCDs, but also the other properties of which, such as for example their mechanical properties and heat resistance, do not differ substantially from molding compositions and shaped articles having no antistatic properties.

### SUMMARY OF THE INVENTION

A film comprising transparent polycarbonate, transparent, acrylate-based polymeric particles and an antistatic agent is disclosed. The particles have core-shell morphology and their average diameter is 1 to 100 μm. The film that may be multilayered is suitable as a diffuser of flat screens.

### DETAILED DESCRIPTION OF THE INVENTION

This object is surprisingly achieved by a film or multilayer film system made from thermoplastic molding compositions which contain at least one antistatic agent and light-scattering particles. The multilayer system preferably contains at least two layers, wherein at least one of these layers contains an antistatic agent and light-scattering particles and at least one layer of a thermoplastic matrix material that is free of scattering agent and/or antistatic agent.

The multilayer system preferably contains at least two layers of one or various thermoplastics, wherein at least one layer contains a thermoplastic which contains at least one antistatic agent and light-scattering particles.

The present invention provides a film containing 76 to 99.89 wt. % of a transparent polycarbonate, 0.01 to 20 wt. % of transparent, acrylate-based polymeric particles having core-shell morphology, wherein these polymeric particles have an average particle diameter of between 1 and 100 μm, and 0.1 to 4.0 wt. % of an antistatic agent.

A film comprising two or more layers is particularly preferred, wherein one layer contains 76 to 100 wt. % of a transparent polycarbonate, optionally 0.01 to 20 wt. % of transparent, polymeric acrylate-based particles with a core-shell morphology, these polymeric particles having an average particle diameter of between 1 and 100 μm, and optionally 0.1 to 4 wt. % of an antistatic agent, and at least one further layer contains optionally 0.1 to 4 wt. %, relative to the layer, of an antistatic agent and optionally 0.01 to 20 wt. % of transparent, polymeric acrylate-based particles with a core-shell morphology, these polymeric particles having an average particle diameter of between 1 and 100 μm, wherein the transparent particles and the antistatic agent must be present in the stated concentration in at least one layer.

The thickness of the entire multilayer system is preferably 50 μm to 1000 μm, particularly preferably 70 μm to 800 μm and very particularly preferably 100 μm to 700 μm.

The total thickness of the layer or layers which contain(s) the antistatic agent is preferably between 1 μm and 100 μm, preferably 10 μm to 75 μm, particularly preferably 20 μm to 50 μm. The total thickness of the layer or layers which contain no antistatic agent is particularly preferably between 20 μm and 600 μm.

Perfluoralkyl sulfonates in preferred quantities of 0.1 to 2 wt. %, particularly preferably of 0.1 to 1 wt. % are preferably added to the plastics as an antistatic agent.

Mixing of the individual constituents may proceed in known manner either successively or simultaneously, and either at room temperature or at a higher temperature.

Incorporation of the additives into the molding compositions according to the invention, in particular the antistatic agents and light-scattering additives and further above-stated additives, proceeds in known manner by mixing polymer pellets with the additives at temperatures of approx. 200 to 350° C. in conventional units such as internal kneaders, single-screw extruders and twin-screw extruders for example by melt compounding or melt extrusion or by mixing solutions of the polymer with solutions of the additives in suitable organic solvents such as CH₂Cl₂, haloalkanes, haloaromatics, chlorobenzene and xylenes and subsequently evaporating the solvents in known manner. The proportion of additives in the molding composition may be varied within broad limits and is determined on the basis of the desired properties of the molding composition.

The proportion of light-scattering additives in the molding composition is a positive amount up to 30 wt. %, preferably 0.01 to 20 wt. %, relative to the weight of the molding composition.

It has been found that, as diffuser films containing an antistatic agent preferably a perfluoroalkylsulfonic acid salt, these films exhibit unexpectedly high luminance in the above described BLUs. This effect is manifested still more strongly in connection with the film set (Table 1) typically used in a backlight unit (BLU).

A film set in a stacked set of film, comprising e.g. diffuser-films, brightness enhancement films (BEF), dual brightness enhancement films (DBEF) or polarizing films.

These diffuser films furthermore exhibit distinctly reduced surface resistance relative to comparison samples without an antistatic agent. This may be demonstrated, not only by determining surface resistance but also by the films performance under the conditions of the with the dust test described in the Examples. During assembly of the BLUs, these films accordingly exhibit the favorable property of attracting little dust from the surroundings.

Surface resistance and the results of the dust test are shown in Table 2.

The perfluoroalkylsulfonic acid salt used in Example 4 comprises diisopropyl dimethylammonium perfluorobutanesulfonate (Structure 1), which is particularly suitable as an antistatic agent.

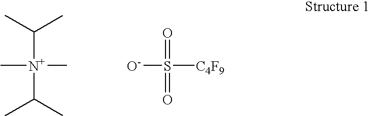

The present invention also provides the use of the films according to the invention as diffuser films for flat screens, in particular for backlighting LCD displays.

The films according to the invention exhibit elevated transmittance with simultaneously elevated light scattering and may for example be used in the illumination systems of flat screens (LCD screens). Elevated light scattering with simultaneously elevated transmittance are of vital significance in this application. The illumination system of such flat screens may be provided either with lateral light injection (edgelight system) or, at larger screen sizes, in which lateral light injection is not adequate, by means of a backlight unit (BLU), in which the direct illumination behind the diffuser sheet must be distributed as uniformly as possible (direct light system).

Polycarbonates which are suitable for the production of the plastics composition according to the invention are any known polycarbonates. These are homopolycarbonates, copolycarbonates and thermoplastic polyester carbonates.

The suitable polycarbonates preferably have weight average molecular weights ( M̅_{w}) of 18,000 to 40,000, preferably of 26,000 to 36,000 and in particular of 28,000 to 35,000, determined by measuring relative solution viscosity in dichloromethane or in mixtures of equal quantities by weight of phenol/o-dichlorobenzene, calibrated by light scattering.

The polycarbonates are preferably produced by the phase boundary process or the melt-transesterification process and the following description of production by the phase boundary process is provided by way of example.

This process for the synthesis of polycarbonate has been described in the literature; reference is made by way of example to H. Schnell, Chemistry and Physics of Polycarbonates, Polymer Reviews, vol. 9, Interscience Publishers, New York 1964 pp. 33 et seq., to Polymer Reviews, vol. 10, “Condensation Polymers by Interfacial and Solution Methods”, Paul W. Morgan, Interscience Publishers, New York 1965, chapt. Vm, p. 325, to Dr. U. Grigo, Dr. K. Kircher und Dr. P. R. Müller “Polycarbonate” in Becker/Braun, Kunststoff-Handbuch, volume 3/1, “Polycarbonate, Polyacetale, Polyester, Celluloseester”, Carl Hanser Verlag Munich, Vienna 1992, pp. 118-145 and to EP-A 0 517 044.

Suitable diphenols are described, for example, in U.S. Pat. Nos. 2,999,835; 3,148,172; 2,991,273; 3,271,367; 4,982,014 and 2,999,846, in German published patent applications 1,570,703; 2,063,050; 2,036,052; 2,211,956 and 3,832,396, French patent 1,561,518, in the monograph, “H. Schnell, Chemistry and Physics of Polycarbonates, Interscience Publishers, New York 1964, pp. 28 et seq.; pp. 102 et seq.”, and in “D. G. Legrand, J. T. Bendler, Handbook of Polycarbonate Science and Technology, Marcel Dekker New York 2000, pp. 72 et seq.”.

Polycarbonates may also be produced from diaryl carbonates and diphenols by the known polycarbonate melt phase process or “melt transesterification” process, which is described for example in WO-A 01/05866 and WO-A 01/05867. Transesterification processes (acetate process and phenyl ester process) are additionally described for example in U.S. Pat. Nos. 3,494,885; 4,386,186; 4,661,580; 4,680,371 and 4,680,372, in EP-A 26,120; 26,121; 26,684; 28,030; 39,845; 39,845; 91,602; 97,970; 79, 075; 146,887; 156,103; 234,913 and 240,301 and in DE-A 1,495,626 and 2,232,977.

Both homopolycarbonates and copolycarbonates are suitable. Copolycarbonates according to the invention may also be produced as component A by using 1 to 25 wt. %, preferably 2.5 to 25 wt. % (relative to the total quantity of diphenols to be used) of polydiorganosiloxanes with hydroxyaryloxy end groups. These are known (for example from U.S. Pat. No. 3,419,634) and may be produced using known processes. The production of copolycarbonates containing polydiorganosiloxanes is described in DE-OS 3,334,782 for example.

Polyester carbonates and block copolyester carbonates, particularly those as are described in WO 2000/26275, are also suitable. Aromatic dicarboxylic acid dihalides for the production of aromatic polyester carbonates are preferably the diacid dichlorides of isophthalic acid, terephthalic acid, 4,4-diphenyletherdicarboxylic acid and 2,6-naphthalenedicarboxylic acid.

The aromatic polyester carbonates may be both linear and branched in known manner (see in this respect also DE-OS 2,940,024 and DE-OS 3,007,934).

The polydiorganosiloxane-polycarbonate block polymers may also be a mixture of polydiorganosiloxane-polycarbonate block copolymers with conventional thermoplastic polycarbonates containing no polysiloxane, wherein the total content of polydiorganosiloxane structural units in this mixture amounts to approx. 2.5 to 25 wt. %.

Such polydiorganosiloxane-polycarbonate block copolymers are characterized in that they contain in the polymer chainaromatic carbonate structural units (1) and polydiorganosiloxanes containing aryloxy end groups (2).

Such polydiorganosiloxane-polycarbonate block copolymers are known, see for example U.S. Pat. Nos. 3,189,662; 3,821,325 and 3,832,419.

Preferred polydiorganosiloxane-polycarbonate block copolymers are produced by reacting polydiorganosiloxanes containing alpha,omega-bishydroxyaryloxy end groups together with other diphenols, optionally with simultaneous use of branching agents in conventional quantities, for example in accordance with the two-phase boundary process (c.f. in this respect H. Schnell, Chemistry and Physics of Polycarbonates, Polymer Rev. vol. DC, pp. 27 et seq., Interscience Publishers New York. 1964), wherein the ratio of difunctional phenolic reactants is in each case selected such that the content of aromatic carbonate structural units and diorganosiloxy units according to the invention is obtained.

Such polydiorganosiloxanes containing alpha,omega-bishydroxyaryloxy end groups are known; see for example U.S. Pat. No. 3,419,634.

The light-scattering particles to be used according to the invention comprise polymeric acrylate-based particles having core-shell morphology, for example and preferably those which are disclosed in EP-A 634,445.

The polymeric particles have a core of a rubber-like vinyl polymer. The rubber-like vinyl polymer may be a homo- or copolymer of any desired monomer which has at least one ethylenically unsaturated group and enters into addition polymerization under emulsion polymerization conditions in an aqueous medium. Such monomers are listed in U.S. Pat. No. 4,226,752, column 3, lines 40-62.

Most preferably, the polymeric particles contain a core of rubber-like alkyl acrylate polymers, wherein the alkyl group comprises from 2 to 8 carbon atoms, optionally copolymerized with 0 to 5% crosslinking agent and from 0 to 5% graft crosslinking agent, relative to the total weight of the core. The rubber-like alkyl acrylate is preferably copolymerized with up to 50% of one or more copolymerizable vinyl monomers, for example those stated above. Suitable crosslinking and graft-crosslinking monomers are familiar to the person skilled in the art, and are preferably those as are described in EP-A 0 269 324 (=U.S. Pat. No. 5,237,004, incorporated herein by reference).

The core of the polymeric particles may contain residual oligomeric material, which was used in the polymerization process in order to swell the polymer particles, but such oligomeric material has a sufficient molecular weight in order to prevent the diffusion thereof, or to prevent its being extracted during processing or use.

The polymeric particles contain one or more shells. This or these shell or shells are preferably produced from a vinyl homo- or copolymer. Suitable monomers for the production of the shell/shells are listed in U.S. Pat. No. 4,226,752, column 4, lines 20-46, reference being made to the details stated in this respect. A shell or two or more shells are preferably a polymer of a methacrylate, acrylate, vinyl arene, vinyl carboxylate, acrylic acid and/or methacrylic acid.

The polymeric particles are used for imparting light-scattering properties to the transparent plastics, preferably polycarbonate. The refractive index n of the core and of the shell/shells of polymeric particles is preferably within +/−0.25 units, more preferably within +/−0.18 units, most preferably within +/−0.12 units of the refractive index of the polycarbonate. The refractive index n of the core and of the shell/shells is preferably no closer than +/−0.003 units, more preferably no closer than +/−0.01 units, most preferably no closer than +/−0.05 units to the refractive index of the polycarbonate. The refractive index is measured in accordance with Standard ASTM D 542-50 and/or DIN 53 400.

The polymeric particles generally have an average particle diameter of at least 1 and at most 100 micrometres, preferably of at least 2 micrometres, more preferably of 2 to 50 micrometres, most preferably of 2 to 15 micrometres. “Average particle diameter” should be taken to mean the number average. Preferably at least 90%, most preferably at least 95% of the polymeric particles have a diameter of more than 2 micrometres. The polymeric particles are a free-flowing powder, preferably in compacted form.

The polymeric particles may be produced in known manner. In general, at least one monomer component of the core polymer is subjected to emulsion polymerization with formation of emulsion polymer particles. The emulsion polymer particles are swollen with the same or one or more other monomer components of the core polymer, and the monomer(s) is (are) polymerized within the emulsion polymer particles. The stages of swelling and polymerization may be repeated until the particles have grown to the desired core size. The core polymer shell is polymerized from the monomer(s) onto the polymer particles in the second emulsion. One or more shells may be polymerized onto the core polymer. The production of core/shell polymer particles is described in EP-A 0,269,324 and U.S. Pat. Nos. 3,793,402 and 3,808,180 incorporated herein by reference.

It has furthermore surprisingly been found that brightness values may be further increased by using a small quantity of optical brightener.

One particular embodiment of the invention accordingly provides a plastics film according to the invention which may additionally contain 0.001 to 0.2 wt. %, preferably approx. 1000 ppm of an optical brightener from the class of bis-benzoxazoles, phenylcoumarins or bis-styrylbiphenyls.

One particularly preferred optical brightener is Uvitex OB from Ciba Specialty Chemicals.

The films according to the invention are preferably produced by extrusion.

For the purposes of extrusion, polycarbonate pellets are supplied to the extruder and melted in the extruder's plasticizing system. The plastics melt is pressed through a slot die and so shaped, transformed into the desired final shape in the nip of a polishing calender and set in shape by alternating cooling on polishing rolls and the ambient air. The polycarbonates with elevated melt viscosity used for extrusion are conventionally processed at melt temperatures of 260 to 320° C., the temperatures of the plasticizing barrel and the die temperatures being set correspondingly.

By using one or more ancillary extruders and suitable melt adaptors upstream from the slot die, polycarbonate melts of different compositions may be superposed one on the other, so producing multilayer sheets or films (see for example EP-A 0,110,221 and EP-A 0,110,238).

Both the base layer and optionally present coextruded layer(s) of the shaped article according to the invention may additionally contain additives such as for example UV absorbers and other conventional processing auxiliaries, in particular mold release agents and rheological agents and the conventional stabilizers for polycarbonates, in particular heat stabilizers and antistatic agents, optical brighteners. Different additives or concentrations of additives may be present in each layer.

In one preferred embodiment, the composition of the solid sheet additionally contains 0.01 to 0.5 wt. % of a UV absorber selected from the group consisting of benzotriazole derivatives, dimeric benzotriazole derivatives, triazine derivatives, dimeric triazine derivatives and diaryl cyanoacrylates.

The coextruded layer may contain UV absorber and mold release agent.

Suitable stabilizers are for example phosphines, phosphites or Si-containing stabilizers and further compounds described in EP-A 0,500,496. Triphenyl phosphites, diphenylalkyl phosphites, phenyldialkyl phosphites, tris-(nonylphenol) phosphite, tetrakis-(2,4-di-tert.-butylphenyl)-4,4′-biphenylene diphosphonite, bis-(2,4-dicumylphenyl) pentaerythritol diphosphite and triaryl phosphite may be stated by way of example. Triphenylphosphine and tris-(2,4-di-tert.-butylphenyl) phosphite are particularly preferred.

Suitable mold release agents include esters or partial esters of mono- to hexahydric alcohols, in particular of glycerol, of pentaerythritol or of Guerbet alcohols.

Monovalvent alcohols include stearyl alcohol, palmityl alcohol and Guerbet alcohols, a divalent alcohol is for example glycol, a trihydric alcohol is for example glycerol, tetrahydric alcohols include pentaerythritol and mesoerythritol, pentahydric alcohols include arabitol, ribitol and xylitol, hexahydric alcohols include mannitol, glucitol (sorbitol) and dulcitol.

The esters are preferably the monoesters, diesters, triesters, tetraesters, pentaesters and hexaesters or mixtures thereof, in particular random mixtures, of saturated, aliphatic C₁₀ to C₃₆ monocarboxylic acids and optionally hydroxy-monocarboxylic acids, preferably with saturated, aliphatic C₁₄ to C₃₂ monocarboxylic acids and optionally hydroxy-monocarboxylic acids.

Commercially obtainable fatty acid esters, in particular of pentaerythritol and of glycerol, may contain, as a result of their production process, <60% of various partial esters.

Suitable saturated, aliphatic monocarboxylic acids with 10 to 36 C atoms include capric acid, lauric acid, myristic acid, palmitic acid, stearic acid, hydroxystearic acid, arachidic acid, behenic acid, lignoceric acid, cerotic acid and montanic acids.

Further examples of suitable antistatic agents are cationically active compounds, for example quaternary ammonium, phosphonium or sulfonium salts, anionically active compounds, for example alkyl sulfonates, alkyl sulfates, alkyl phosphates, carboxylates in the form of alkali metal or alkaline earth metal salts, nonionogenic compounds, for example polyethylene glycol esters, polyethylene glycol ethers, fatty acid esters, ethoxylated fatty amines.

The following Examples are intended to illustrate the invention in non-limiting manner.

### EXAMPLES

In order to produce films by extrusion, the polycarbonate pellets are introduced into the feed hopper of an extruder and pass from there into the plasticizing system that includes a screw and barrel.

The plasticizing system conveys and melts the material. The plastics melt is pressed through a slot die. A filter arrangement, melt pump, stationary mixing elements and further components may be provided between the plasticizing system and slot die. The melt leaving the die emerges onto a polishing calender. Final shaping proceeds in the nip of the polishing calender. A rubber roll was used to provide a texture on one side. The rubber rolls used for texturing the film surface are disclosed in DE 32 28 002 (or its equivalent U.S. Pat. No. 4,368,240) of Nauta Roll Corporation. The film is finally set in shape by cooling, specifically in alternating manner, on the polishing rolls and in the ambient air. The remaining equipment serves to convey, apply protective film to and wind up the extruded films.

The invention is illustrated further by means of the following Examples.

### Example 1

Compounding:

Production of the Light-Scattering Masterbatch.

Production of the light-scattering compound with conventional twin-screw compounding extruders (for example ZSK 32) at processing temperatures of 250 to 330° C. conventional for polycarbonate.

A masterbatch of the following composition was produced:
Makrolon 3108 polycarbonate from Bayer MaterialScience AG in a proportion of 80 wt. %
Core-shell particles with a butadiene/styrene core and a methyl methacrylate shell Paraloid EXL 5137 from Rohm & Haas with a particle size of 2 to 15 μm and an average particle size of 8 μm in a proportion of 20 wt. %.

### Example 2

Production of the Antistatic Agent Masterbatch was Carried Out in a Twin-Screw Extruder (ZSK 32) at 250 to 330° C.

A masterbatch of the following composition was produced:
Makrolon 3108 polycarbonate in a proportion of 98 wt. %
Diisopropyl dimethylammonium perfluorobutanesulfonate as a colorless powder in a proportion of 2 wt. %.
   Film Coextrusion

The machinery and apparatus used to produce the optionally coextruded films comprise:
an extruder with a screw of 60 mm diameter (D) and a length of 33×D. The screw comprises a devolatilizing zone;
a coextruder for applying the outer layer with a screw of length 25 D and a diameter of 35 mm
a melt pump;
a crosshead;
a special coextrusion slot die with a width of 450 mm;
a three-roll polishing calender with horizontally arranged rolls, the third roll being swivellable by +/−45° relative to the horizontal;
a roller conveyor;
thickness measuring means
a device for applying protective film onto both sides;
a haul-off device;
winding station.

The base material pellets were introduced into the feed hopper of the main extruder. The particular material was melted and conveyed in the barrel/screw plasticizing system. The two material melts were brought together in the coextrusion die. The melt emerges from the die onto the polishing calender, the rolls of which are at the temperature stated in Table 1. Final shaping and cooling of the material proceed on the polishing calender. A rubber roll was used to provide a texture on one side of the film surface. The film is then conveyed by a haul-off, the protective film is applied onto both sides, after which the film is wound.

TABLE 1

| | Typical processing parameters | |
|---|---|---|
| Process parameters | Main extruder | Coextruder |
| Extruder temperature, Z1 | 220° C. | 250° C. |
| Extruder temperature, Z2 | 280° C. | 260° C. |
| Extruder temperature, Z3 | 280° C. | 260° C. |
| Extruder temperature, Z4 | 280° C. | 260° C. |
| Extruder temperature, Z5 | 280° C. | 260° C. |
| Extruder temperature, Z6 | 280° C. | |
| Crosshead temperature | 280° C. | |
| Die/side plate temperature | 280° C. | |
| Die temperature, Z13 | 280° C. | |
| Die temperature, Z14 | 280° C. | |
| Die temperature, Z15 | 280° C. | |
| Die/side plate temperature | 280° C. | |
| Die temperature, Z17 | 280° C. | |
| Die temperature, Z18 | 280° C. | |
| Die temperature, Z19 | 280° C. | |
| Rotational speed, extruder | 60 min⁻¹ | 12 min⁻¹ |
| Rotational speed, melt pump | 44 min⁻¹ | |
| Roll 1 temperature (textured rubber | 40° C. | |
| roll) | | |
| Roll 2 temperature | 100° C. | |
| Roll 3 temperature | 130° C. | |
| Calender speed | 13.8 m/min. | |
| Throughput | 38 kg/h | |
| Film width/thickness | 385 mm/100 μm | |

### Comparative Example 3

Main Extruder

A compound of the following composition was blended:
Makrolon 3100 polycarbonate from Bayer MaterialScience AG in a proportion of 94.0 wt. %
Masterbatch prepared according to Example 1 in a proportion of 6.0 wt. %.
   Coextruder

A compound of the following composition was blended:
Makrolon 3100 polycarbonate in a proportion of 100.0 wt. %

This was used to extrude a film with a smooth side on the transparent polycarbonate layer, a textured surface on the light-scattering layer (base layer), and a total layer thickness of 125 μm, which contained 1.2 wt. % of scattering additive in the 100 μm thick base layer and no antistatic agent in the 25 μm thick coextruded layer.

### Example 4

Main Extruder

A compound of the following composition was blended:
Makrolon 3100 polycarbonate in a proportion of 94.0 wt. %
Masterbatch according to Example 1 in a proportion of 6.0 wt. %.
   Coextruder

A compound of the following composition was blended:
Makrolon 3100 polycarbonate in a proportion of 80.0 wt. %
Masterbatch according to Example 2 in a proportion of 20 wt. %.

This was used to extrude a film with a smooth side on the transparent polycarbonate layer, a textured surface on the light-scattering layer (base layer), and a total layer thickness of 125 μm, which contained 1.2 wt. % of scattering additive in the 100 μm thick base layer and 0.4 wt. % of antistatic agent (diisopropyl dimethylammonium perfluorobutanesulfonate) in the 25 μm thick coextruded layer.

Dust Test

In order to investigate dust deposition in a laboratory test, the injection molded sheets were exposed to an atmosphere with suspended dust. To this end, a 2 liter beaker with an 80 mm long magnetic stirring bar of triangular cross-section was filled to a depth of approx. 1 cm with dust (coal dust/20 g activated carbon, Riedel de Haen, Seelze, Germany, item no. 18 003). The dust is put into suspension using the magnetic stirrer. Once the stirrer had been stopped, the test specimen is exposed to this dusty atmosphere for 7 seconds. Depending on the test specimen used, a greater or lesser amount of dust is deposited on the test specimens.

Dust deposition (dust pattern) is evaluated visually. Films exhibiting dust patterns were rated negative (−), while films exhibiting virtually no dust patterns were rated (+).

Surface Resistance Measurements

The antistatic action of the light-scattering films is determined by measuring surface conductivity according to DIN IEC 93.

Optical Measurements

The films described in Example 3 (comparative) and Example 4 were evaluated as to their optical properties in accordance with the following standards and using the following measuring instruments:

Transmittance (Ty (C2°)) was determined using an Ultra Scan XE from Hunter Associates Laboratory, Inc. Light reflection (Ry (C2°)) was determined using a Lambda 900 from Perkin Elmer Optoelectronics. A Hazegard Plus instrument from Byk-Gardner was used for determining haze (to ASTM D 1003). The half-value value angle, HW, as a measure of the strength of the light-scattering action, was determined with a goniophotometer according to DIN 58161. Luminance measurements (brightness measurements) were carried out with an LS 100 Luminance Meter from Minolta on a backlight unit (BLU) from DS LCD (LTA320W2-L02, 32″ LCD TV panel).

Optical Measurement Results

Luminance (brightness) measurements were performed with the above-stated backlight unit in order to measure and evaluate the films to be investigated. To this end, that film from the existing film set comprising three films which lies directly on the diffuser plate was replaced with the film to be tested. The other two films were then put back on top again.

TABLE 2

| | Comparative | | | |
|---|---|---|---|---|
| | Example 3 | | Example 4 | |
| Transmittance [%] (C2°) | 85.2 | | 85.54 | |
| Hunter Ultra Scan | | | | |
| Reflection [%] (C2°) | 10.68 | | 10.5 | |
| Hunter Ultra Scan | | | | |
| Haze [%] | 95.6 | | 92 | |
| Half-value angle [°] | 9.2 | | 6.5 | |
| Side texture | Smooth | matt | smooth | matt |
| Dust test | − | − | + | + |
| Surface resistance | 1.0 * 10¹⁷ | 2.3 * 10¹⁷ | 4.4 * 10¹⁴ | 6.1 * 10¹⁴ |
| [Ω/□] | | | | |

| | | |
|---|---|---|
| Brightness [cd/m²] | 6024 | 6069 |
| without films | | |
| Brightness [cd/m²] | 7184 | 7390 |
| with films | | |

The content of scattering agent is identical in all the Examples listed in Table 1. The base material used is also the same. In Example 4, the antistatic agent of structure 1 (diisopropyl dimethylammonium perfluorobutanesulfonate) is present in the coextruded layer. At an identical scattering agent content and thus identical diffusing action, this film surprisingly exhibits higher luminance than Comparative Example 3.

A comparison of the brightness is instructive. This variable was measured as follows: matching portions were cut out of the films from Examples 3 and 4 and fitted to a backlight unit (BLU) from DS LCD (LTA320W2-L02, 32″ LCD TV panel). Brightness was then determined without the film set used in this backlight unit. The film which lies directly on the diffuser plate was then replaced with the film to be investigated. Brightness was measured at a total of 9 different points on the backlight unit (using Minolta Luminance Meter LS 100) and the average calculated.

It is clear from the Examples that brightness is lower without the film set than with the film set. Surprisingly, the brightness of the film according to the invention is even better than that of the comparison sample.

Although the invention has been described in detail in the foregoing for the purpose of illustration, it is to be understood that such detail is solely for that purpose and that variations can be made therein by those skilled in the art without departing from the spirit and scope of the invention except as it may be limited by the claims.

What is claimed is:

1. A film comprising 76 to 99.89% of a transparent polycarbonate, 0.01 to 20% of transparent, acrylate-based polymeric particles and 0.1 to 4.0 wt. % of an antistatic agent said particles having core-shell morphology, and average particle diameter of 1 to 100 μm.

2. The film according to claim 1, wherein the antistatic agent comprises perfluoralkyl sulfonates.

3. The film according to claim 1, having a thickness of 0.05 to 1 mm.

4. The film according to claim 1, comprising two or more layers.

5. The film according to claim 4, wherein at least one layer contains 76 to 100. % relative to the weight of said one layer of a transparent polycarbonate, optionally 0.01 to 20% relative to the weight of said one layer of said particles and optionally 0.1 to 4. % relative to the weight of said one layer of said antistatic agent, and at least one further layer contains optionally 0.1 to 4%, relative to the weight of said further layer, of an antistatic agent and optionally 0.01 to 20. % relative to the weight of said further layer of said particles wherein said particles and said antistatic agent are present in the stated concentration in at least one layer.

6. The film according to claim 5, wherein said one layer contains 0.1 to 4.0 wt. % of an antistatic agent.

7. The film according to claim 6, wherein the antistatic agent comprises diisopropyl dimethylammonium perfluorobutanesulfonate.

8. The film according to claim 4, with a total thickness of 0.05 to 1 mm.

9. A diffuser film of flat screens comprising the film of claim 1.
